(19) United States
(12) Patent Application Publication
(10) Pub. No.: US 2012/0183791 A1
(43) Pub. Date: Jul. 19, 2012

(54) METHOD FOR APPLYING AT LEAST ONE ANTI-CORROSIVE, LIQUID COATING AGENT COMPRISING METAL PARTICLES TO A WORKPIECE, AND DEVICE THEREFOR

(75) Inventors: Gerhard Reusmann, Essen (DE); Thomas Kruse, Dortmund (DE); Christian Rabe, Iserlohn (DE); Thorsten Neveling, Hagen (DE); Martin Gruen, Hofheim (DE)

(73) Assignee: EWALD DOERKEN AG, Herdecke (DE)

(21) Appl. No.: 13/387,383

(22) PCT Filed: Jul. 12, 2010
(86) PCT No.: PCT/EP2010/059998

§ 371 Date: Apr. 5, 2012

(30) Foreign Application Priority Data
Jul. 27, 2009 (DE) 10 2009 034 869.7

(51) Int. Cl. B32B 15/04; B05D 1/38; B05D 5/00; B05D 3/02; B05D 3/00; B05D 1/36; B05C 9/14

(52) U.S. Cl. 428/457; 427/372.2; 118/58; 427/532; 427/558; 427/559

(57) ABSTRACT

A method for applying at least one anticorrosive, liquid, metal-particle-containing coating agent to a workpiece (2) with the steps application of a first layer of a coating agent to the workpiece (2) application of a second layer of a coating agent to the first layer. In order to suggest measures that permit a time-efficient application of a two-layer coating made of anticorrosive, liquid, metal-particle-containing coating agent, it is provided that the second layer is applied while the first layer still needs to dry.

### BACKGROUND OF THE INVENTION

The invention relates to a method for applying at least one anticorrosive liquid coating agent comprising metal particles to a workpiece and a device therefor.

An effective corrosion protection for metallic surfaces of workpieces represents one of the most important requirements for long-term use of the same. Typical examples of such workpieces are screws, bolts, nuts, washers, hinge parts, springs, but also large parts like housing parts or steel beams. A surface is considered metallic in this case when it is made of a metal or respectively an alloy. Possible metals are hereby in particular iron, zinc, manganese, copper, chromium and titanium, which can be present alone or together within an alloy. As is known to a person skilled in the art, alloys can also contain semimetals or nonmetals like carbon or silicon.

One option for realizing corrosion protection for such metallic surfaces, which is widely known in the state of the art, is the application of an anticorrosive, metal-particle-containing coating agent to the workpiece. The metal particles hereby provide an anodic and/or cathodic corrosion protection for the workpiece lying below it.

The contained metal particles can be of various types. These can be composed in particular of zinc, aluminum, tin, magnesium, nickel, cobalt, manganese, titanium or alloys thereof. It is also conceivable to mix particles of different metals or alloys. The particles can be present in the shape of flakes, granules, powder or a combination thereof. Zinc plates or zinc alloy plates have proven to be particularly advantageous.

In addition to metal particles, coating agents of the named type typically contain at least one binding agent as well as water and/or organic solvents. The binding agent serves to form a permanent, resistant coating film after an annealing process, into which the metal particles are embedded. In the beginning, the binding agent can be liquid or solid. Water as well as organic solvents (including e.g. test gasoline, low-molecular alcohols, ketones, acetone, acetate, glycols and glycol ether) serve primarily to make the coating agent easily processable so that application is possible through painting, spraying or the like. This also results in reactions between the binding agent and water, which are decisive for the annealing process.

Typical binding agents include silanes, in particular organofunctional silanes, e.g. γ-glycidoxypropyltrimethoxysilane. Along with silanes, siloxanes, for instance, methyloxypolysiloxane or silicates, for instance, alkali silicates or alkyl silicates are also suitable. Furthermore, binding agents based on titanates or zirconates are considered as well as chromium VI compounds, which can be added e.g. in the form of salts like ammonium or alkali chromates. Mixtures of the named binding agents, thus e.g. of silanes and titanates, which during annealing can form a common polymer, are also suitable. Furthermore, organic binding agents such as epoxides, urethanes, acrylates, (e.g. methyl methacrylate) and/or polyester can be used as organic copolymers in connection with the above named inorganic binding agents.

Moreover, a plurality of additives is known in the state of the art, with which the properties of the liquid coating agent or the annealed coating film are set. This includes anticorrosion additives (e.g. alkali, alkaline earth or rare earth salts as well as phosphates), thickening agents (e.g. methyl cellulose, magnesium silicate or xanthan gum), lubricants (e.g. polytetrafluoroethylene, polyvinylidene fluoride, molybdenum sulfide, boron nitride, graphite or carnauba wax), tensides, defoaming agents or biocides.

Such a coating agent is typically applied to the workpiece in liquid form and annealed in a further process step after a drying process. However, a single-layer coating is insufficient for many applications.

The simultaneous coating of several small workpieces (bulk small parts) generally takes place in a basket, which is dipped in a bath with liquid coating agent. Contact points between the workpieces can thereby prevent a complete coating. In the same manner, workpieces that are inserted in a frame into a coating bath (frame products) can have contact points with the frame. These non-coated contact points may also require a second layer of a coating agent.

In these cases, two layers are thus applied one after the other. Before applying the second layer, the first layer is dried in DE 10 2006 012 103, DE 10 2004 034 645 or WO 2005/090502. During this drying process, liquid components of the coating agent, such as water or organic solvents evaporate at least partially, often predominantly or completely. A second layer of liquid coating agent, which is then also dried, is applied to this at least predominantly solid layer.

During the subsequent annealing, the binding agent contained in the coating agent reacts, often through crosslinking or respectively polymerization, to become a hard, resistant coating film. Certain coating agents also harden readily under normal conditions. However, the annealing can be considerably accelerated by high temperatures between 120° C. and 350° C. or may even only be enabled hereby. Radiation, in particular infrared and/or UV radiation can also contribute to the acceleration of the annealing. Thermal annealing can take place in an oven, which is heated electrically or by means of combustion. Convection ovens are particularly suitable.

In another variant of the known method, a first layer is dried before applying the second layer. As already demonstrated, volatile components of the coating agent are hereby evaporated. However, there is no annealing, as e.g. through polymerization. Later annealing can hereby take place simultaneously for both layers.

The drying process for the first layer is hereby preferably limited to the absolute minimum both with respect to the duration as well as the temperatures used. As known to a person skilled in the art, the drying can be forced by an air flow (e.g. in a convection oven). This is not performed below room temperature.

In the case of the method according to the state of the art, the first layer is dried and annealed before the second layer is applied, dried and annealed.

In this process flow, the drying or respectively annealing processes represent a capacity bottleneck. The object of the invention is to remove this bottleneck.

### SUMMARY OF THE INVENTION

The object is solved through a method and a device as disclosed herein.

In the case of the method according to the invention for applying at least one anticorrosive, liquid coating agent comprising metal particles to a workpiece, a first layer of a coating agent is first applied to the workpiece. Here and below, the term coating agent, if not explicitly specified otherwise, always refers to anticorrosive coating agents comprising, metal particles that are applied in a liquid state. The term basecoat is also used for this coating agent. The coating agent can hereby contain all components known from the state of the art. In this respect, the above list of potential components should not be considered conclusive or restrictive.

Workpieces that can be coated with the method according to the invention generally have a metallic surface since the coating agents described above are designed for this. It is hereby possible that the workpiece only has a metallic surface or is metallic in full. However, application of the method according to the invention on non-metallic surfaces is generally also possible. Bulk small parts like screws, bolts, nuts, etc. are preferably coated with the method according to the invention. However, the method is also well suited for larger workpieces like frame products.

After applying the first layer, a second layer of a coating agent is applied to the first layer. However—in contrast to the state of the art—the first layer is not annealed before the second layer is applied. Rather, the second layer is applied while the first layer is still annealing, i.e. it is applied to the not yet annealed first layer.

The invention is based on the knowledge that the first layer has sufficiently good cohesion and shows sufficient adhesion on the workpiece even without previously completed annealing. This non-annealed coating film can also serve as the basis for the application of another layer.

As already mentioned, it can occur in particular in the case of bulk small parts that through the resting of the workpieces against each other partial areas of the surface of the workpiece are not achieved during the application of the first layer. At these locations, if applicable, the second layer is applied directly to the workpiece and not to the first layer. The formulation “to the first layer” explicitly includes these cases in connection with the present invention. It is also possible that, according to plan, the first layer is only applied sectionwise to the workpiece or respectively, according to plan, the second layer is only applied sectionwise to the first layer.

Decisive advantages result through the method according to the invention. Thus, the method leads to considerably energy savings. The annealing, as already explained in greater detail above, is typically performed while heating the applied coating agent. Since the coating agent is in thermal contact with the workpiece, at least partial heating of the workpiece is also unavoidable. If a thermally supported annealing of the first layer and the second layer takes place separately, the energy for heating the workpiece is used twice since the workpiece inevitably cools off, or must cool off, in the meantime in order to allow the second coating step. If one considers that workpieces made of metal that have good thermal conductivity and their heat capacity considerably exceeds that of the coatings (only fractions of millimeters thin), the resulting energy savings is clear when two annealing process are replaced by one. In light of increasing energy prices, this is not only an ecological but also a considerable economic advantage.

There are also time savings. Since the separate annealing of the first layer is omitted, several minutes of time are saved in the coating process. If one considers that the annealing takes a considerable portion of the entire coating process, one fourth or more of the entire process duration may be saved.

It is thus obvious that the method according to the invention saves time, energy and cost.

However, according to the invention, the first layer is not dried before the application of the second layer. Rather, the first layer and the second layer are dried after the application of the second layer, i.e. the second layer is applied to the not yet dry first layer. It has hereby been shown that the first layer, as a liquid film, already shows good adhesion to the workpiece in many cases, so that a drying before the application of the second layer is not required.

Additionally in the case of numerous coating agents, in particular solvent-containing coating agents, the solid content of the coating agent film increases through virtually spontaneous volatilization of liquid components, i.e. not caused by active drying. Thus, this non-dried film can also serve as the basis for the application of another layer.

The described variant according to the invention also includes a procedural method, in which both layers are directly thermally annealed without a separate, previously performed drying. This type of annealing also inevitably causes an evaporation of volatile, liquid components of the coating agent, i.e. drying, due to the used temperatures. Thus, in this connection, this method is also called the drying of the two layers, even if there is technically no difference between drying and annealing here.

The named variant also has other advantages. The energy expenditure can be further reduced. The drying, as will be explained in greater detail below, is typically performed while heating the applied coating agent. As with annealing, a heating of the workpiece is hereby unavoidable. Thus, the energy to heat the workpiece is also used twice here when the two layers are dried separately. In contrast, considerable energy savings results when two drying processes are replaces by one. In turn, the time expenditure with respect to the state of the art is reduced since the drying of the first layer is omitted. If one considers that drying and annealing durations lie in the same order of magnitude, the resulting time advantage becomes clear.

With respect to the coating agent to be applied, two variants of the method are conceivable. In a first variant, the same coating agent is applied during the first and the second application. In this case, a classic, two-layer coating results that mainly differs from a single-layer coating through its thickness, but is homogenous in its composition.

However, in a second variant, different coating agents can be applied during the first and during the second application. The difference can e.g. relate to the fact that the first layer contains more metal particles than the second or that the second layer has a higher lubricant content than the first layer. This second variant opens up interesting options for combining coating agents with different properties.

The application of coating agents can takes place according to the state of the art in different manners. Application through dipping, pouring, spraying and/or spattering is preferred. For example, application through spraying has the advantage that a dosing of the applied quantity of the coating agent can hereby be achieved if applicable, while application through dipping is particularly suitable for reaching all areas of a workpiece, including depressions and hollow areas. It is possible that both layers are applied in the same manner or in different manners. The use of different methods for application of one layer is also conceivable.

If the second layer of the coating agent is applied through dipping, then this can, depending on the coating agent, carry with it the danger of the redissolution of components of the first layer. Thus, the second layer is preferably applied through pouring, spraying and/or sputtering. These methods are particularly suited for not compromising the first layer.

Many coating agents dry with time without requiring special measures. However, it is advantageous to accelerate the drying process. Thus, the drying takes place, even in the case of the joint drying of the two layers, preferably through the effect of temperature and/or by means of a hot or cold air flow. The temperature effect can hereby take place e.g. through infrared radiation or through insertion into an oven, which is heated electrically or through combustion. Advantageously, the duration is hereby at most 5 minutes, preferably at most 1 minute, most preferably at most 30 seconds. As a rule, the minimum drying duration is 3 seconds. The temperature is advantageously at most 100° C., preferably at most 80° C., most preferably at most 50° C.

As is known to a person skilled in the art, the drying process can also be accelerated through an air flow, which carries evaporated components of the coating agent away from the surface of the workpiece. In this connection, the term air flow also includes every type of flow of a gas or respectively gas mixture, even if conventional air represents the closest selection for most applications. The combination of temperature and air flow, such as in a convection oven, is particularly effective. The drying can take place discontinuously or continuously, e.g. in a throughfeed method. In the case of the first, at least one workpiece is inserted into a drying area, remains there for a certain period of time for drying and is then removed again from the drying area. In the case of the latter, each workpiece is moved through the drying area, e.g. on a conveyor belt, and is dried by it as it passes through.

As is known to a person skilled in the art, more coating agent is almost always applied than necessary for formation of a closed coating film during application methods like spraying, dipping, etc. Excess coating agent leads to an uneven coating film, makes drying processes difficult and can greatly impact the properties of the finished coating. In a preferred embodiment of the method according to the invention, excess coating agent is thus removed before the second application of a coating agent. This can be performed by means of different methods, which are known from the state of the art.

Dripping off, centrifuging and/or blowing off are hereby preferred. Dripping off is hereby the removal of excess liquid alone due to gravity, while centrifugal forces also come into play during centrifuging. Both during dripping off as well as during centrifuging, the workpiece can be individually suspended or located in a container, e.g. a basket, with a permeable wall. The latter is particularly preferred in the case of bulk small parts. A dripping off can also take place on a conveyor belt designed as a sieve, which permits the draining off of coating liquid. A blowing off takes place by means of a (normally cold) air flow, which is pointed at the surface of the workpiece. This can be performed in continuous mode. It is understood that such an air flow is generally suitable in the case of a longer effect for the drying of the coating agent. However, this effect is low during blowing off. The air flow only operates until the excess coating liquid is removed. The content of liquid components of the coating liquid remaining on the workpiece is hereby changed insignificantly at best. There is thus no drying as performed after the application of the second layer. The shown methods can also advantageously be combined, e.g. through centrifugation with intermediary pauses, during which dripping off can also take place.

During the coating of bulk small parts, the workpieces are typically arranged next to each other, cover each other partially and inevitably touch each other at least pointwise. These are factors that make the comprehensive application of the second layer difficult if not impossible. Thus, in a further development of the method, in which the application of the first layer takes place on several workpieces takes place, the workpieces are separated before the second application of a coating agent. Separating includes all measures that lead to the pairwise distancing of the workpieces from each other, i.e. so that a gap is created between two workpieces. The gap is preferably at least half the largest linear expansion of a workpiece. A trouble-free application of the second layer is possible through the separation.

A mechanical acceleration is particularly frequently used for separating, such as through the transfer from a slow to a fast conveyor belt or the centrifuging from a rotating turn table. Alternatively, vibrating or scattering devices or separation by means of magnets can be used, in which e.g. electro or permanent magnets are configured for individual picking of workpieces out of large quantity.

As is known from the state of the art, the applied binding agent layers are also generally annealed during the method according to the invention, however with the stipulation that the first layer and the second layer are annealed simultaneously and jointly. It is also preferred in the case of the method according to the invention that the workpiece is pretreated before applying the coating. Possible treatment methods here are in particular cleaning, degreasing, etching, sand blasting, compressed air blasting and/or phosphating.

It is provided in a further development of the invention that, after previous drying or annealing of the first and the second layer, a single- or multi-layer top coat is applied to the two-layer coating. In this context, each coating that comprises a binding agent but does not contain any metal pigments for corrosion protection is designated as a top coat, i.e., there is no differentiation between “top coat” and “sealing”. The possibility exists that the top coat along with color pigments and other components, which are known to a person skilled in the art, contains certain quantity of metal particles for creating a “metallic look”.

The method according to the invention can be performed by means of a device specially designed for this. This involves a device for the coating of workpieces with at least one anticorrosive, liquid, metal-particle-containing coating agent.

In a first variant, the device comprises first means for applying a coating agent, second means for applying a coating agent as well as means for the annealing of an applied coating agent. The means for application can be designed differently, e.g. as dip, pour or spray devices. Means for annealing are for example oven, infrared or UV lamps.

Finally, the device comprises means of conveyance for workpieces, which define a conveying path, which connects the first means for applying with the second means for applying and the second means for applying with the means for annealing. The means of conveyance can be designed differently, e.g. as a robot arm with a claw or magnet, as a constantly mechanical conveyor (e.g. as a conveyor belt, roller conveyor or chain conveyor), as a gravity conveyor (e.g. as chute or roller track) or as a pneumatic conveyor. In particular, a combination of the named means is also conceivable.

The conveying path is the path along which a workpiece in operating mode is moved by the means of conveyance. The first means for applying are hereby arranged on the conveying path in front of the second means for applying, i.e. in operating mode the workpiece is conveyed from the first means for applying to the second means for applying.

In this variant of the device, all means for annealing are arranged on the conveying path behind the second means for applying. This differentiates the present device from known devices, in which means for annealing are also arranged between the first and second means for applying so that the workpiece in operating mode is conveyed from the first means for applying to the means for annealing and subsequently to the second means. This first variant of the device is designed for the joint annealing of the two layers of the coating agent.

In a second variant, the device comprises first means for applying a coating agent, second means for applying a coating agent as well as means for the drying of an applied coating agent. Different means for drying are known to a person skilled in the art and their modes of operation were already explained above.

In this second variant, the device also comprises means for conveying workpieces. These define here a conveying path, which connects the first means for applying with the second means for applying and the second means for applying with the means for drying. The first means for applying are in turn arranged on the conveying path in front of the second means for applying, i.e. in operating mode the workpiece is conveyed from the first means for applying to the second means for applying.

In this variant of the device, all means for drying are arranged on the conveying path behind the second means for applying. This differentiates the present device from known devices, in which means for drying are also arranged between the first and second means for applying so that the workpiece in operating mode is conveyed from the first means for applying to the means for drying and subsequently to the second means. This second variant of the device is designed for the joint drying of the two layers of the coating agent.

However, the two variants do not exclude each other. The device preferably comprises both means for drying as well as means for annealing. The means for annealing are hereby generally arranged below the means for drying. As already mentioned above, the means for annealing can also be identical to the means for drying.

If the device also comprises means for drying in addition to the means for annealing in accordance with the first version, then all means for drying are arranged behind the second means for applying (which means a combination of the first and second variants).

In addition to the named components, the device can comprise means for removing excess coating agent, means for separating the workpieces and means for annealing the coating agent. The means for removing and the means for separating are hereby typically arranged on the conveying path between the first means for applying and the second means for applying. The mode of operation of these means was already explained above and is familiar to a person skilled in the art.

### BRIEF DESCRIPTION OF THE DRAWINGS

Details of the invention are explained below using exemplary embodiments with reference to the figures. They show in:

FIG. 1: a schematic representation of a first coating unit for executing an exemplary embodiment of the method according to the invention with separate drying and joint annealing of two coating agent layers and

FIG. 2: a schematic representation of a second coating unit for executing an exemplary embodiment of the method according to the invention with joint drying and joint annealing of two coating agent layers.

### DETAILED DESCRIPTION

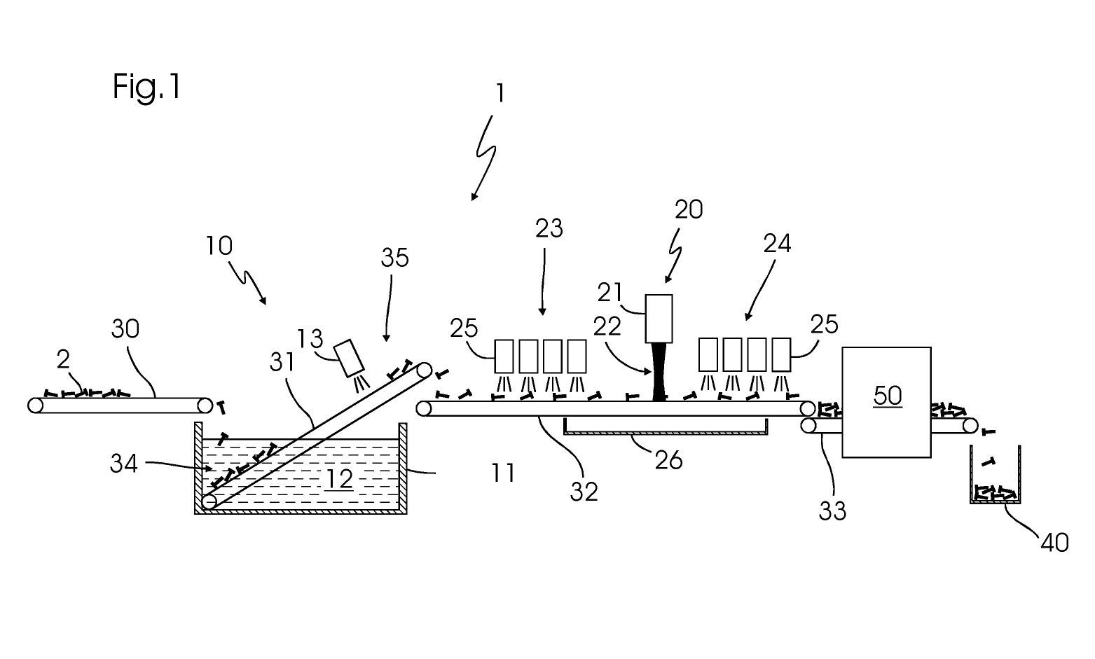

The coating unit 1 shown in FIG. 1 for executing a method according to the state of the art comprises as main elements a first coating station 10 for the application of a first layer of coating agent, a first drying station 23 for the drying of the first layer, a second coating station 20 for the application of a second layer of coating agent, a second drying station 24 for drying the second layer as well as a convection oven 50 for the annealing of the coating agent. The first coating station 10 comprises a dipping tank 11, in which a coating bath 12 of a base coat, i.e. of an anticorrosive, liquid, metal-particle-containing coating means, is located.

A first conveyor belt 30, which leads to the dipping tank 11, serves to bring in workpieces 2. A second conveyor belt 31 leads out of the dipping tank 11. For this reason, the conveying direction of the second conveyor belt 31 does not run horizontal, but rather diagonally upward. In order to prevent a rolling or gliding down of workpieces 2, the second conveyor belt 31 has a surface structure with a series of webs (not shown) located diagonally to the conveying direction. The second conveyor belt 31 runs through the coating bath 12 in the shown operating state of the unit 1 in a lower area 34. It runs through an upper area 35 below a blowing station 13 and ends above a third conveyor belt 32, which is in turn aligned horizontally.

The third conveyor belt 32 passes one after the other through the first drying station 23, the second coating station 20, which comprises a pouring device 21 arranged within the second conveyor belt 32, as well as the second drying station 24. Each of the drying stations 23, 24 is formed by a series of hot air blowers 25, which are pointed toward the third conveyor belt 32.

A fourth conveyor belt 33 is connected to the third conveyor belt 32, which runs through the convection oven 50.

Both the second and the third conveyor belt 32 are designed as a sieve, whereby a flowing off of liquid coating agent is enabled.

Steel screws 2 are provided for coating in the shown unit 1. For this, they are previously degreased at 75° C. in a cleaning solution composed of water in which 1 liter water, 9 g of potassium phosphate and 27 g potassium hydroxide were dissolved, and then cleaned with tap water. The degreasing and cleaning procedure is repeated again and the screws are then dried.

The screws 2 are given to the second conveyor belt 30, which runs with a speed of 10 cm/s. At the end of the first conveyor belt 30, the screws 2 fall into the coating bath 12, which in the present case has the following composition:

9.0% by weight γ-glycidoxypropyltrimethoxysilane
0.7% by weight boric acid
4.7% by weight acetone
0.8% by weight 1-nitropropane
25.9% by weight metal particles
3.4% by weight nonionic, ethoxyalated nonylphenol wetting agent
0.4% by weight sodium bis tridecyl sulfosuccinate anionic wetting agent
55.0% by weight water

The flake-shaped metal particles have a thickness of approximately 0.1 to 0.5 μm and a longest dimension of the individual particle of approximately 80 μm. They are made of an alloy of 95% zinc with 5% aluminum.

The arrangement of the first 30 and second conveyor belt 31 is hereby such that the screws 2 land on the second conveyor belt 31. A certain separation of screws 2 already occurs hereby through the falling and the landing on the second conveyor belt 31. The screws 2 are conveyed by the second conveyor belt 31, which is also operated at 10 cm/s, diagonally upward out of the dipping tank 11, whereby excess coating agent can run off the screws 2 through the open structure of the conveyor belt 31.

The screws 3 now have a first layer of coating agent. In order to support the runoff of excess coating agent from the screws 2, liquid is blown off the screws 2 by the blowing station 13, which generates a cold air flow of approximately 20 m/s.

At the end of the second conveyor belt 31, the screws 2 fall onto the third conveyor belt 32, which is operated at a speed of 30 cm/s. Further separation occurs through the associated acceleration of the screws 2. The screws 2 now run through the first drying station 23. This comprises a series of hot air blowers 25, which generate air flows of approximately 5 m/s and 70° C. The drying takes 4-5 seconds. Through the effect of the same, liquid components of the coating means are largely evaporated, whereupon the first layer is dried until it is no longer removed or damaged without a strong mechanical action.

Further along, the screws 2 are transported under and through the pouring device 21 of the second coating station 20. The pouring station 21 has a series of outlet openings (not shown) for a coating agent, which in this case is identical to that in the dipping tank 11. The pouring device 21 generates a very tight pouring curtain 22, through which a normally seamless application of second coating agent to the first layer of coating agent takes place.

While the screws 2 are transported on, excess coating means runs off due to the sieve structure of the third conveyor belt 32. The running off coating agent is caught in a reservoir 26 and can be reused. In the following, the screws 2 run through the second drying station 24. This also includes hot air blowers 25, the structure and operating parameters of which correspond with those of the first drying station 23. After passing through the second drying station 24, the second layer is also dry.

At the end of the third conveyor belt 32, the screws 2 fall onto the fourth conveyor belt 33, which is operated at 2 cm/s. The separation of the screws 2 is hereby reversed, but this is insignificant since the coating agent is dry and no further coating takes place. The screws 2 now run through the convection oven 50, where both layers of the coating agent are annealed at 320° C. At the end of the third conveyor belt 33, the screws 2 fall into a container 40, by means of which they can be transported away.

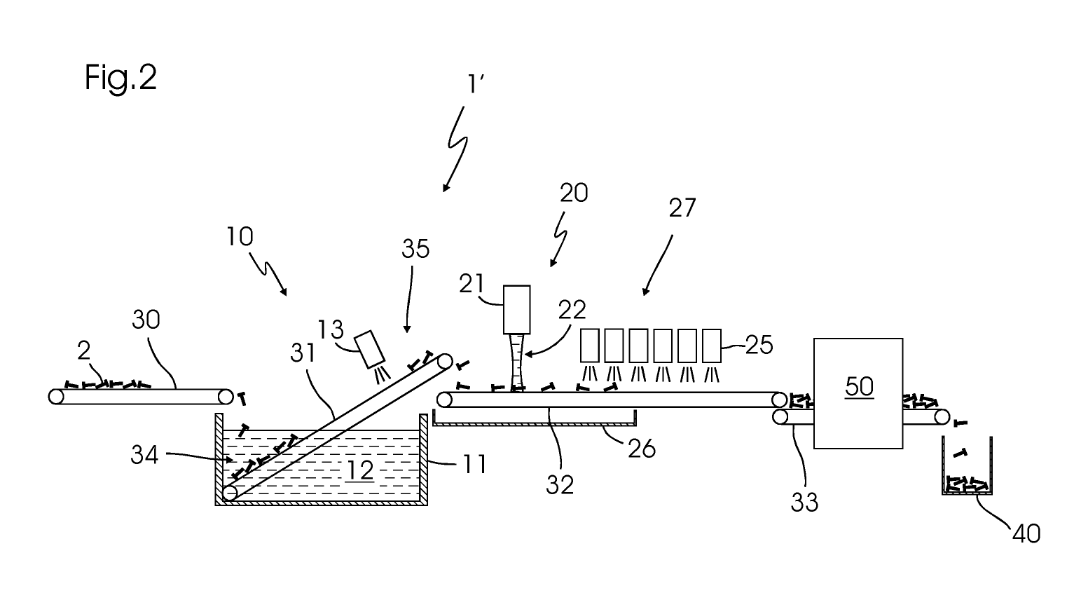

FIG. 2 shows a second coating unit 1′ for executing the method according to the invention. This also comprises a first coating station 10 for the application of a first layer of coating agent as well as a second coating station 20 for the application of a second layer of coating agent. However, a separate drying station 27 is provided here, which is located upstream of a convection oven 50 for the annealing of the coating agent.

The structure of this coating device 1′ is largely identical to that of the device 1 shown in FIG. 1. Thus, a detailed explanation of the individual elements as well as the operating mode is omitted if they match.

In contrast to the initially described device 1, the third conveyor belt 32 runs through the second coating station 20 as well as the drying station 27; thus, a drying device is not located upstream of the second coating station 20. The drying station 27 is formed in turn by a series of hot air blowers 25, which are pointed toward the third conveyor belt 32.

After screws 2 were provided with a first layer of coating agent in the dipping tank 11 and excess coating agent was blown off by means of the blowing station 13, the screws 2 fall from the second conveyor belt 31 onto the third conveyor belt 32.

The screws 2 are now transported on the third conveyor belt 32 below and through the pouring device 21 of the second coating station 20 without being previously dried. With this device 1′, both layers of coating agent are rather dried jointly. For this, the screws 2 run through the drying station 27 after the second coating station 20. Structure and operating parameters of the hot air blowers 25 correspond with those of drying stations 23, 24 of the first exemplary embodiment. After passing through the drying station 27, both layers are dried enough so that they are no longer removed or damaged without a strong mechanical action.

Both layers are then jointly annealed in the convection oven 50.

1. Method for applying at least one anticorrosive liquid coating agent comprising metal particles to a workpiece (2) with the steps
application of a first layer of a coating agent to the workpiece (2)
application of a second layer of a coating agent to the first layer,
wherein the first layer and the second layer are dried after the application of the second layer.

2. The method according to claim 1, wherein the same coating agent is applied during the first and during the second application or different coating agents are applied.

3. The method according to claim 1, wherein excess coating agent is removed before the second application of a coating agent.

4. The method according to claim 1, wherein the application of the first layer to several workpieces (2) takes place and the workpieces (2) are separated before the second application of a coating agent.

5. The method according to claim 1, wherein the first layer and the second layer are annealed jointly.

6. The method according to claim 1, wherein a single-layer or multi-layer top coat is applied after previous drying or annealing of the first layer and the second layer.

7. Device (1) for the coating of workpieces (2) with at least one anticorrosive, liquid, metal-particle-containing coating agent, comprising
first means (11) for applying a coating agent,
second means (21) for applying a coating agent,
means (50) for the annealing of applied coating agent as well as
means (30, 31, 32, 33) of conveyance for workpieces (2), which define a conveying path, which connects the first means (11) for applying with the second means for applying (21) and the second means for applying (21) with the means (50) for annealing,
wherein the first means (11) for applying are arranged on the conveying path in front of the second means (21) for applying,
wherein all means (50) for annealing are arranged on the conveying path behind the second means (21) for applying.

8. The workpiece coated with an anticorrosive, metal-particle-containing coating agent, which was applied in liquid form in a first and in a second layer, and wherein the annealing took place after the second layer was applied.

9. The method according to claim 5, wherein the first layer and the second layer are annealed jointly through the effect of temperature and/or radiation.

10. The method according to claim 9, wherein the first layer and the second layer are annealed jointly through infrared and/or UV radiation.
